(19) United States
(12) Patent Application Publication
(10) Pub. No.: US 2006/0100083 A1
(43) Pub. Date: May 11, 2006

(54) Disc stacking arrangement

(76) Inventors: Torgny Lagerstedt, Stockholm (SE); Caes Inge, Saltsjo-Duvnas (SE); Peter Franzen, Tullinge (SE); Olve Maehans, Tullinge (SE); Martin Sandgren, Nacka (SE)

Correspondence Address: YOUNG & THOMPSON, 745 SOUTH 23RD STREET, 2ND FLOOR, ARLINGTON, VA, 22202, US

(21) Appl. No.: 10/526,361

(22) PCT Filed: Sep. 2, 2003
(86) PCT No.: PCT/SE03/01357

§ 371 Date: Nov. 28, 2005

(30) Foreign Application Priority Data
Sep. 2, 2002 (SE) 0202587-2

(51) Int. Cl. B04B 1/08

(52) U.S. Cl. 494/70

(57) ABSTRACT

Centrifuge for purifying flowing fluid media, has a plurality of stacked concentric disc elements, each provided with a central fluid inlet hole. The disc elements have through openings and the disc elements are slipped thereonto at least three substantially axially extending, circumferentially spaced guide elements for guiding the disc elements circumferentially and radially. The disc elements are held together by end elements at the ends of the stack of discs. The guide elements are completely separate, combined guidance and tensile rods, which are disposed so as not to encroach on the central flow space in the disc stack. The through openings in the disc elements are made as notches, radially directed from the central fluid inlet hole in the disc elements, and the tensile rods are disposed to be inclined somewhat towards the rotational centre from the lower end element when mounting the disc elements.

### TECHNICAL FIELD

The present invention relates to an arrangement in a centrifuge for purifying flowing fluid media, said centrifuge comprising a plurality of concentrically stacked disc elements provided with at least a centrally disposed fluid inlet hole, said disc elements having through openings by means of which the disc elements are slipped onto at least three essentially axially standing, circumferentially spaced, guide elements for guiding the disc elements circumferentially and radially, and said disc elements being held together by end elements at the ends of the stack of discs, said guide elements being in the form of separate tensile rods, which are disposed to cooperate with the end elements in such a manner that the end elements are displaceable relative to each other when compressing the disc elements, means being arranged to lockingly engage the combined guiding and tensile rods to hold the disc elements m a compressed state.

### BACKGROUND OF THE INVENTION

In arrangements of this type for purifying a liquid from undesirable particles there is sometimes used a fixed guiding and tensioning element in the form of a central so-called wing cross to make possible both radial and polar guidance and compression of a large number of stacked conical plates or disc elements (“insert plates”) with the aid of pressure elements at either end of the stack of discs. The pressure elements can be upper and lower end plates which are coupled together via threads with the fixed guidance and tensioning element, or by a housing surrounding and rotating together with the disc stack and having upper and lower halves coupled together. By tightening the end plates to the guidance and tensioning element or to the halves of the housing, the disc elements are pressed together in the stack to make a stable unit.

In centrifuges for gas purification, it is, however, not advantageous to work with an outer rotating housing. Nor is the use of a central wing cross suitable. This limits the flow space for the gas medium flowing into the centre of the disc stack. Furthermore, the mounting of the disc elements on the fixed guide elements is problematic and requires precision and narrow dimensional tolerances.

U.S. Pat. No. 5,637,217 describes a centrifuge for separating particles from a circulating liquid and has features of the type which are disclosed in the preamble to claim 1. The through openings through the disc elements in this centrifuge are, however, not made to simplify the mounting of the disc element and the tensioning bars.

### THE PURPOSE AND SOLUTION OF THE INVENTION

One purpose of the present invention is to achieve a centrifuge in which the disc elements can be easily assembled into a disc stack on the guide elements and be compressed by the end compression elements cooperating with the guide elements, while at the same time assuring that there will be a large central flow space for the inflowing medium to be purified.

For this purpose the arrangement described by way of introduction is characterized according to the invention in that the through openings in the disc elements for the tensile rods are in the form of notches radially directed from the central fluid inlet hole in the disc elements.

In order to additionally simplify assembly of the disc elements, the tension bars are disposed when the disc elements are slipped onto the same to be able to be inclined somewhat inwards towards the rotational centre from one end element to facilitate stacking. After mounting of the last disc element, the bars are pressed outwardly for mounting of the upper end element.

In the event of a rotor breakdown, to prevent the more rigid end elements from striking and damaging a surrounding housing, these are preferably made with an outer diameter which is less than the outer diameter of the disc elements. The more deformable, thin disc elements will strike the housing instead.

Additional features and advantages of the present invention will be evident from the following detailed description with reference to the accompanying drawing.

### SHORT DESCRIPTION OF THE DRAWING

FIG. 1 is a partially sectioned side view of a centrifuge arrangement according to the present invention;

FIG. 2 is a plan view of the arrangement in FIG. 1;

FIG. 3 is an exploded View in perspective of the arrangement in FIGS. 1 and 2; and

FIG. 4 is an enlarged detail view of the area circled in FIG. 1, showing the coupling together of an upper pressure element with a guiding and tensioning element in the arrangement according to FIGS. 1-3.

### DETAILED DESCRIPTION OF A PREFERRED EMBODIMENT

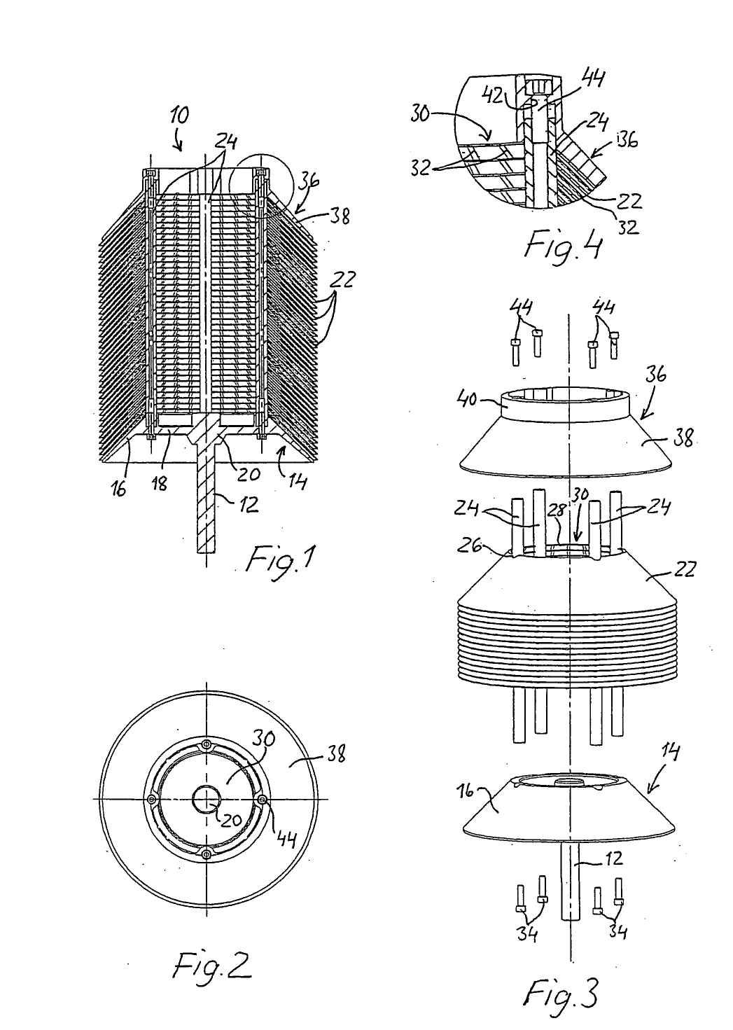

In FIG. 1, 10 designates a rotor of a centrifuge for purifying a gas medium. The rotor 10 has a bottom element 14 which is integrated with a drive shaft 12 and has a conical collar 16, which is connected via a radial web portion 18 and a hub 20, to a centrally placed drive shaft 12. Onto the bottom element 14 there are stacked a plurality of spacer elements in the form of conical discs 22. The discs 22 are stacked with the aid of four axially directed guide rods 24, which are mounted evenly distributed peripherally. Each disc 22 has, for this purpose, four corresponding guide grooves or through openings 26, which preferably extend radially into the discs 22 from an inner circumferential edge 28, which defines a central inlet hole 30 for the gas medium to be purified. The discs 22 are held spaced from each other a small distance in the axial direction by means of suitable spacers, e.g. radial ridges 32, which are indicated in FIG. 4.

The guide rods 24, which can be made as a long tubular elements with an inner thread at their ends, are, at their lower ends shown in FIGS. 1 and 3, fixed in the bottom element 14 by means of screws 34. At the upper ends of the guide rods 22, a pressure plate 36 is applied. The pressure plate 36 has a conical collar portion 38 which abuts against the top of the upper disc 22 in the stack as well as a hub portion 40 with four mounting holes 42 (FIG. 4) for the upper ends of the guide rods 24. Screws 44 engage the thread in the upper ends of the guide rods 22 and press the conical collar portion 38 against the upper disc 22 in the stack, to thereby hold the discs 22 stably together and press them between the bottom element 14 and the pressure plate 36 of the rotor 10. The rods 24 are in this case both guide elements for stacking the discs 22, and pressure elements for pressing them together, at the same as they encroach minimally on the central flow space for the gas medium to be purified, flowing into the rotor.

In order to facilitate slipping the discs 22 onto the guide rods 24, the guide rods are preferably disposed during assembly to be inclined somewhat inwardly towards the rotational centre. This can be achieved by making the mounting holes for the guide rods 24 and the bottom element 14 somewhat inwardly inclined or by bending the rods 24 somewhat inwardly by means of the first mounted disc element. When mounting the pressure plate 36 on top of the uppermost disc 22, the rods 24 can be pressed into their respective through openings 26 in the discs. Any clearances or gaps between the rods 24 and the through openings 26 (guide grooves) can be taken up by the rods being pressed outwardly by the centrifugal forces during operation. Such an intentional gap can further facilitate the mounting of the discs 22.

It is suitable to make the pressure plate 36 and the bottom element 14 with an outer diameter which is somewhat less than the outer diameter of the discs 22. In the event of breakdown of the rotor shaft 12, the more deformable discs 22, preferably made of a plastics material, will come into contact with a surrounding housing, instead of the more rigid bottom element 14 or the pressure plate 36, coming into contact with the surrounding housing, thus minimising damage to the centrifuge.

Many modifications of the device are conceivable within the scope of the invention. For example, instead of screws 34, 44, nuts can be used which engage externally threaded end portions of the guide rods 24. The number of guide rods 24 should be at least three, but can be more than four. Furthermore, the end portion of the rotor, integrated with the drive shaft, can be a displaceable pressure plate for the stack of discs, while the opposite end element can be a fixed component with guide rods on which the discs are mounted.

1. Arrangement for a centrifuge for purifying flowing fluid media, said centrifuge comprising a plurality of concentrically stacked disc elements (22) provided with at least a centrally disposed fluid inlet hole (30), said disc elements (22) having through openings (26) by means of which the disc elements (22) are slipped onto at least three essentially axially standing, circumferentially spaced, guide elements (24) for guiding the disc elements circumferentially and radially, and said disc elements (22) being held together by end elements (14, 36) at the ends of the stack of discs, said guide elements being in the form of separate tensile rods (24), which are disposed to cooperate with the end elements (14, 36) in such a manner that the end elements are displaceable relative to each other when compressing the disc elements (22), means (34, 44) being arranged to lockingly engage the combined guidance and tensile rods (24) to hold the disc elements (22) in a compressed state, characterized in that the through openings (26) in the disc elements (22) for the tensile rods (24) are in the form of notches radially directed from the central fluid inlet hole (30) in the disc elements (22).

2. Arrangement according to claim 1, characterized in that the tensile rods (24) are arranged upon slipping of the disc elements (22) onto the same, to be inclineable somewhat inwards towards the rotational centre from one of the end elements (14) to facilitate mounting.

3. Arrangement according to claim 1, characterized in that the end elements (14, 36) have an outer diameter which is less than the outer diameter of the disc elements (22).

4. Arrangement according to claim 2, characterized in that the end elements (14, 36) have an outer diameter which is less than the outer diameter of the disc elements (22).
